(19) United States
(12) Patent Application Publication
(10) Pub. No.: US 2021/0221390 A1
(43) Pub. Date: Jul. 22, 2021

(54) VEHICLE SENSOR CALIBRATION FROM INTER-VEHICLE COMMUNICATION

(71) Applicant: QUALCOMM Incorporated, San Diego, CA (US)

(72) Inventors: Volodimir SLOBODYANYUK, San Diego, CA (US); Mohammed Ataur Rahman SHUMAN, San Diego, CA (US); Arnold Jason GUM, San Diego, CA (US)

(21) Appl. No.: 16/748,747

(22) Filed: Jan. 21, 2020

(51) Int. Cl. B60W 50/02; H04W 4/40; G01S 7/40; G01S 7/497

(52) U.S. Cl. CPC B60W 50/0225; H04W 4/40; B60W 2050/0083; G01S 7/497; G01S 7/40

(57) ABSTRACT

The calibration of a vehicle sensor can be conducted based on communication between vehicles. A first vehicle needing sensor calibration can receive calibration information from a second vehicle, indicating the location of a calibration marker at one or more times. The first vehicle can then compare the calibration information with measurement information of the calibration marker made by a sensor, and recalibrate the sensor based on a comparison of the calibration information and measurement information. According to some embodiments, vehicles may leverage existing vehicle-to-vehicle communications (e.g., Cellular vehicle-to-everything (V2X) communication) to broadcast calibration capabilities.

### BACKGROUND

Modern vehicles are frequently equipped with a number of sensors of different types to enhance the driving experience and increase passenger safety. These sensors can include, for example, cameras, radars, LIDARs, and the like. Information from these sensors can be used to determine an accurate location of the vehicle with respect to the road and nearby objects including other vehicles. This location information can impact the functionality of safety systems, autonomous or semi-autonomous driving systems, and/or other vehicle systems. And thus, accurate sensor information can be particularly important to the safety not only of those in the vehicle but people nearby as well.

### BRIEF SUMMARY

Techniques described herein provide for sensor calibration based on communication between vehicles. In particular, a first vehicle needing sensor calibration can receive calibration information from a second vehicle, indicating the location of a calibration marker at one or more times. The first vehicle can then compare the calibration information with measurement information of the calibration marker made by a sensor, and recalibrate the sensor based on a comparison of the calibration information and measurement information. According to some embodiments, vehicles may leverage existing vehicle-to-vehicle communications (e.g., vehicle-to-everything (V2X) communication) to broadcast calibration capabilities.

An example of sensor calibration for a sensor of a first vehicle, according to this description, comprises identifying information indicative of a need to calibrate the sensor; and wirelessly receiving, at the first vehicle, a message from a second vehicle, the message indicating availability of calibration information for the sensor. The method further comprises, responsive to identifying the information indicative of the need to calibrate the sensor and receiving the message from the second vehicle, sending a request for the calibration information from the first vehicle to the second vehicle. The method also comprises receiving, at the first vehicle, the calibration information for the sensor, the calibration information including, for one or more times: a timestamp of the respective time, and location information of a calibration marker, indicative of a location of the calibration marker at the respective time. The method further comprises receiving measurement information from the sensor at one or more times, wherein the measurement information at each time is indicative of the location of the calibration marker at the respective time, and calibrating the sensor based on, for the one or more times, a comparison of the location information of the calibration marker at the respective time with the measurement information.

An example mobile computer system, according to this description, comprises a wireless communication interface, a memory, and one or more processing units communicatively coupled with the memory and the wireless communication interface. The one or more processing units are configured to identify information indicative of a need to calibrate a sensor of a first vehicle, and wirelessly receive, via the wireless communication interface, a message from a second vehicle, the message indicating availability of calibration information for the sensor. The one or more processing units are further configured to, responsive to identifying the information indicative of the need to calibrate the sensor and receiving the message from the second vehicle, send a request for the calibration to the second vehicle via the wireless communication interface, and receive, via the wireless communication interface, the calibration information for the sensor, where the calibration information includes, for one or more times: a timestamp of the respective time, and location information of a calibration marker, indicative of a location of the calibration marker at the respective time. The one or more processing units are also configured to receive measurement information from the sensor at one or more times, wherein the measurement information at each time is indicative of the location of the calibration marker at the respective time, and calibrate the sensor based on, for the one or more times, a comparison of the location information of the calibration marker at the respective time with the measurement information

An example device, according to this description, comprises means for identifying information indicative of a need to calibrate a sensor of a first vehicle, and means for wirelessly receiving a message from a second vehicle, the message indicating availability of calibration information for the sensor. The device further comprises means for sending, responsive to identifying the information indicative of the need to calibrate the sensor and receiving the message from the second vehicle, a request for the calibration information from the first vehicle to the second vehicle, and means for receiving the calibration information for the sensor, wherein the calibration information includes, for one or more times: a timestamp of the respective time, and location information of a calibration marker, indicative of a location of the calibration marker at the respective time. The device further comprises means for receiving measurement information from the sensor at one or more times, wherein the measurement information at each time is indicative of the location of the calibration marker at the respective time, and means for calibrating the sensor based on, for the one or more times, a comparison of the location information of the calibration marker at the respective time with the measurement information.

An example non-transitory computer-readable medium, according to this description, has instructions stored thereby for calibrating a sensor of a first vehicle. The instructions, when executed by one or more processing units, cause the one or more processing units to identify information indicative of a need to calibrate a sensor of a first vehicle, wirelessly receive a message from a second vehicle, the message indicating availability of calibration information for the sensor, and responsive to identifying the information indicative of the need to calibrate the sensor and receiving the message from the second vehicle, send a request for the calibration information from the first vehicle to the second vehicle. The instructions, when executed by one or more processing units, further cause the one or more processing units to receive the calibration information for the sensor, the calibration information including, for one or more times: a timestamp of the respective time, and location information of a calibration marker, indicative of a location of the calibration marker at the respective time. The instructions, when executed by one or more processing units, also cause the one or more processing units to receive measurement information from the sensor at one or more times, wherein the measurement information at each time is indicative of the location of the calibration marker at the respective time, and calibrate the sensor based on, for the one or more times, a comparison of the location information of the calibration marker at the respective time with the measurement information.

### BRIEF DESCRIPTION OF THE DRAWINGS

FIG. 1 is a perspective view of a traffic scenario in which the techniques for sensor calibration described herein may be used, according to some embodiments.

FIG. 2 is a call flow diagram illustrating example V2X communication between vehicles, according to an embodiment.

FIG. 3 is a perspective drawing of a scenario illustrating how a calibration marker can be used in sensor calibration, according to an embodiment.

FIG. 4 is a flow diagram of a method of sensor calibration for a sensor of a first vehicle, according to an embodiment.

FIG. 5 is a block diagram of an embodiment of a mobile computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a , 110b , 110c , etc. When referring to such an element using only the first number, any instance of the element is to be understood (e.g., element 110 in the previous example would refer to elements 110-1, 110-2, and 110-3 or to elements 110a , 110b , and 110c ).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

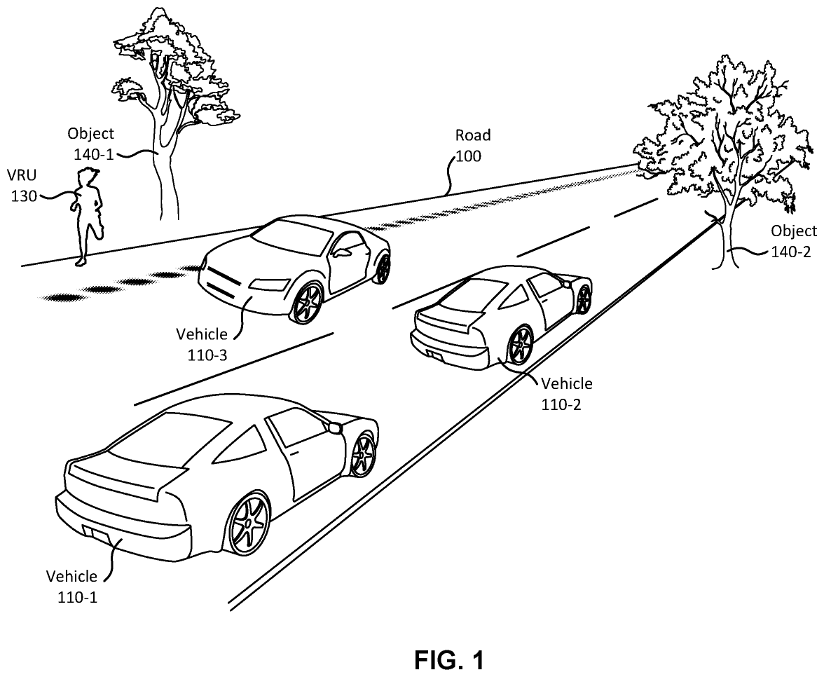

FIG. 1 is a perspective view of a traffic scenario to illustrate how sensors and V2X communications can be utilized to enhance location determination, situational awareness and response, and overall functionality of the various vehicles illustrated, according to some embodiments. Here, the road 100 is shared by vehicles 110-1, 110-2, and 110-3 (collectively and generically referred to as vehicles 110), and a vulnerable road user (VRU) 130. Near the road 100 are trees (generically described as objects 140).

Modern vehicles 110 frequently come equipped with highly accurate positioning systems, based on sensors such as an Inertial Measurement Unit (IMU), Global Navigation Satellite System (GNSS) receiver, and the like. Among other things, these sensors can allow a vehicle 110 to determine its position accurately in a preferred global frame of reference. Furthermore, vehicles 110 may be further equipped with a multitude of perception sensors (e.g. camera, LIDAR, radar, and so forth). These additional sensors can also be used in conjunction with map information to determine the location of the vehicle 110 (e.g., by comparing the position of an observed object to its position on a map), and/or these additional sensors can be used for situational awareness purposes to identify other vehicles 110, objects 140, VRUs 130, and the like. Further, vehicles 110 may be equipped with V2X components or devices, allowing vehicles 110 to engage in communication with other vehicles 110 and V2X-capable entities (e.g., infrastructure-based devices called Road-Side Units (RSUs)). These communications can convey additional location-related and/or situational-awareness-related information, which can provide for more accurate location determination and/or situational awareness.

V2X is a communication technology for the passing of information from a vehicle to any entity that may affect the vehicle, and vice versa, to create this knowledge of a vehicle's surrounding. Cellular V2X (CV2X) is a form of V2X that can use cellular-based communication such as long-term evolution (LTE), fifth-generation (5G), and/or other cellular technologies in a direct-communication mode as defined by the 3rd Generation Partnership Project (3GPP). V2X allows for the passing of information between V2X capable vehicles (e.g., vehicles capable of communicating using C-V2X or any other V2X technology). This allows V2X-capable vehicles to obtain knowledge of the static and dynamic characteristics of surrounding objects by vehicle sensors (ego vehicle sensing) and by information received via V2X from other V2X-capable vehicles and road-side units (RSUs) for cooperative sensing.

As an example, a first vehicle 110-1 may be equipped with autonomous or semi-autonomous driving capabilities. To ensure the first vehicle 110-1 stays in its lane on the road 100, the first vehicle 110-1 may utilize IMU and GNSS information. Additionally, the first vehicle 110-1 may use additional information from onboard sensors (cameras, LIDARs, radars, etc.) and V2X communication received from other vehicles 110-2 and 110-3 to determine the location of the other vehicles 110-2 and 110-3, objects 140, and the like relative to the first vehicle 110-1. This additional information can ensure the first vehicle 110-1 safely navigates the road 100 in view of current traffic conditions.

The accuracy and integrity of sensor information from onboard sensors can be extremely important to provide safe operation of a vehicle. For example, if the first vehicle 110-1 verifies or enhances GNSS-based location by comparing the location of an object captured in a camera image with a corresponding location of the object in a map, the position and orientation of the camera with respect to the first vehicle 110-1 must be known and must be accurate. Otherwise, the vehicle 110-1 may make an incorrect determination of where it is located. This incorrect location determination could cause the first vehicle 110-1 to drive out of its lane or engage in other unsafe functionality, putting the safety of passengers therein at risk. Similarly, the position and orientation of the camera with respect to the first vehicle 110-1 can impact a determination by the first vehicle 110-1 of the location of nearby vehicles 110-2 and 110-3, objects 140, and so forth, relative to the first vehicle 110-1. If, for example, the orientation of a camera or LIDAR on board the first vehicle 110-1 is misaligned, the first vehicle 110-1 may conclude that a second vehicle 110-2 in front of the first vehicle 110-1 is farther away than it really is. This can result in the first vehicle 110-1 following the second vehicle 110-2 too closely, which again may compromise the safety of passengers in the first vehicle 110-1.

Maintaining sensor calibration, therefore, is important for the correct functionality of the vehicle 110-1. Keeping sensors accurately calibrated, however, can be difficult. Traffic accidents, minor fender benders, off-road driving, and even standard on-road travel (speed bumps, dips, potholes, etc.) can cause a sensor to become misaligned or otherwise degrade sensor performance, resulting in inaccurate sensor information that can compromise various vehicular systems. Furthermore, recalibrating sensors at a dealership or vehicle repair center can be burdensome to vehicle owners.

To help ensure the integrity of sensor information (and ultimately the safety of those in and near the first vehicle 110-1), the first vehicle 110-1 may be equipped to perform intrinsic and extrinsic calibration and cross-calibration of sensors. This can include, for example, comparing a detected object within the field of view (FOV) of a camera to ensure it is located at a corresponding position in the FOV of a LIDAR. If not, the vehicle 110-1 may determine that the camera and/or LIDAR has become misaligned and needs to be recalibrated.

Embodiments are disclosed herein for enabling sensor calibration based on communication between vehicles, such as from V2X communications. This process can be initiated, for example, by a broadcast of a V2X message, such as a Basic Safety Message (BSM). The broadcast message may be sent by a vehicle 110 capable of providing calibration information and may include information regarding the availability of the calibration information.

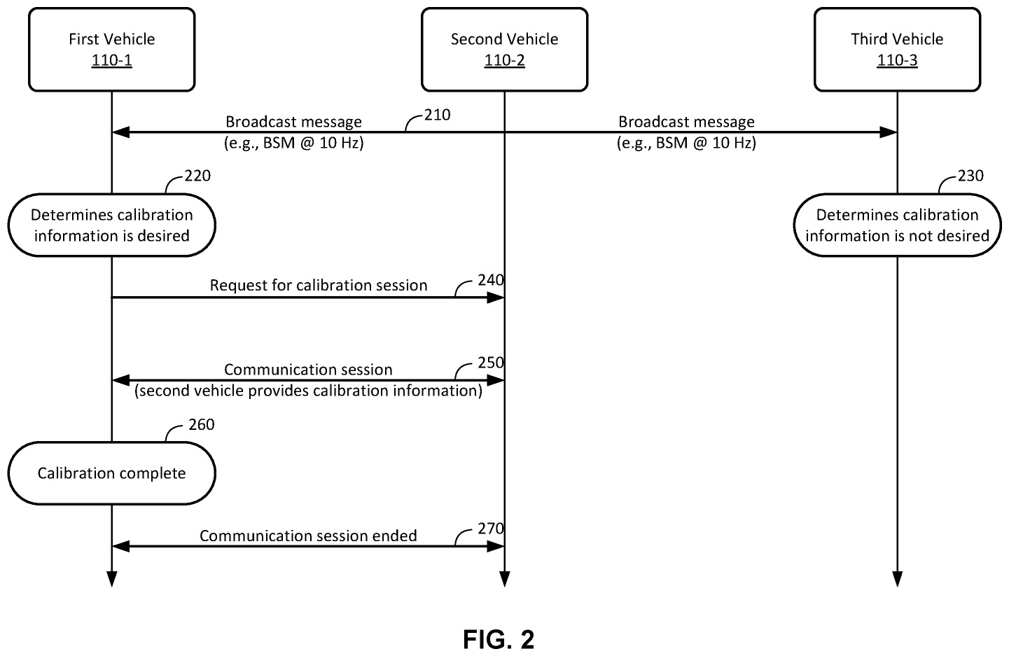

FIG. 2 is a call flow diagram illustrating example V2X communication between vehicles 110 shown in FIG. 1, according to an embodiment. Here, the first vehicle 110-1 recognizes a condition in which at least one onboard sensor needs calibration. This can include, for example, conditions in which the at least one onboard sensor cannot be fully calibrated using other onboard sensors of the vehicle, and calibration using external information is needed. A second vehicle 110-2 is V2X capable and further capable of providing calibration information to nearby vehicles. A third vehicle 110-3 is nearby and within range of V2X messages sent from the first vehicle 110-1 or the second vehicle 110-2. It can be noted that alternative embodiments may implement the illustrated functionality in different ways, using alternative functions and/or flows. A person of ordinary skill in the art will recognize such variations.

At action 210, the second vehicle alerts nearby vehicles of the availability of calibration information by broadcasting this availability in a V2X message. As indicated, this information can be in a common V2X message, such as a BSM message, which is broadcast to nearby vehicles at 10 Hz. (Although not shown in FIG. 2, the first vehicle 110-1 and third vehicle 110-3 may also broadcast BSM messages.) The availability of calibration information can include information regarding the type of sensor the calibration information can be used for (e.g., make/model of the camera, LIDAR, radar, etc.), an indication of the accuracy of the calibration information, an indication of the date and/or time one or more sensors used for determining the calibration information were last calibrated, an indication of the make and/or model of the second vehicle 110-2 (which may be indicative of the type of sensors the second vehicle 110-2 has), pricing information for providing the calibration information, and the like. Alternatively, according to some embodiments, the availability of calibration information may be sent in response to the first vehicle 110-1 sending a request to the second vehicle 110-24 calibration assistance.

The second vehicle 110-2 may determine to broadcast the availability of calibration information for a variety of reasons. For example, in some embodiments, a vehicle providing calibration information may receive money (or something else of value) in exchange for providing the calibration information. Taxis, rideshare vehicles, delivery vehicles, government/municipality vehicles, or other vehicles that are frequently driven, may therefore provide the calibration information as a source of revenue. In some embodiments, a high level of accuracy may be desirable before broadcasting the availability of calibration information. As such, embodiments may limit the ability to broadcast the availability of calibration information to vehicles for which calibration information is based on recently-calibrated sensors, or sensors determined to have an accuracy above a certain threshold. In some embodiments, the value of an exchange of calibration information may be based on an accuracy such that highly-accurate calibration information may be provided at a premium, whereas less-accurate calibration information may be provided for free or at a lower cost.

At action 220, the first vehicle one heard 10-1 determines from the broadcast message that the calibration information from the second vehicle 110-2 is desired to calibrate one or more sensors of the first vehicle 110-1. On the other hand, the third vehicle 110-3 may receive the broadcast message from the second vehicle 110-2 and determined that the calibration information is not needed, at action 230. In the latter case, the third vehicle 110-3 takes no action. However, in the former case, the first vehicle 110-1 sends a request for a calibration session, at action 240, to the second vehicle 110-2.

The first vehicle's determination whether calibration information is desired can be based on a determined need to calibrate one or more sensors. This need can be determined in any of a variety of ways, which may be sensor dependent. For example, data from sensors can be analyzed periodically (e.g., by a processing unit) to determine whether the data is within normal ranges. If sensor data indicates detected objects are moving too fast or are too far away (e.g., beyond a threshold amount from average values), then the first vehicle 110-1 can determine that the sensor needs to be recalibrated. Cross-sensor data may be used to determine whether information from a particular sensor does not look reliable. For example, if multiple images from multiple cameras of the first vehicle 110-1 indicate that an object is at a certain location, but LIDAR information from a LIDAR of the first vehicle 110-1 indicates the object is not at the location, the LIDAR may need calibration. Because modern vehicles are equipped with multiple sensors and sensor types, determination of the need for calibration using cross-sensor data can be particularly useful.

Additionally or alternatively, the first vehicle 110-1 may determine a need to calibrate a sensor based on a detected event. In some embodiments, for example, if an acceleration event occurs in which acceleration exceeds a certain threshold, it may be determined that a sensor needs to be recalibrated. Moreover, it may not necessarily mean that the sensor detecting the acceleration is the sensor to be recalibrated. For example, if the first vehicle 110-1 runs over a pothole and the first vehicle's IMU detects a strong acceleration spike that exceeds acceleration tolerances for a camera mounted on the vehicle, the first vehicle 110-1 can then determine that the camera needs to be calibrated. (In some embodiments, the first vehicle 110-1 may first run diagnostics on the camera, using cross-sensor data and/or other information to verify that the camera needs to be calibrated.)

Time-based events may also cause the first vehicle 110-1 to determine that certain sensors need to be calibrated. That is, the performance of some sensors may degrade over time, under normal usage. Accordingly, if the first vehicle 110-1 determines that a sensor has gone a threshold amount of time (e.g., a recommended amount of time set by the manufacturer) without being calibrated, the first vehicle 110-1 may then determine that the sensor needs to be calibrated.

The first vehicle's determination that one or more sensors need to be calibrated may also be triggered by collision-based events. In addition or as an alternative to acceleration-based events, collision-based events may be detected events indicative of the vehicle colliding with other objects. Sensors on the bumper of the first vehicle 110-1, for example, may be used to determine an impact on the bumper (e.g., from acceleration, orientation, or other sensed characteristics). This data can be used (optionally with cross-sensor data) to determine whether radar, camera, or other sensor embedded in the bumper should be recalibrated.

When the first vehicle 110-1 determines that the sensor may need to be calibrated, it can indicate this to a user of the vehicle. In some embodiments, for example, the first vehicle 110-1 may have an indicator, such as a display or light, indicating the need to calibrate a sensor. In some embodiments, the sensor type may also be included in the indication. In such embodiments, the first vehicle 110-1 may refrain from obtaining calibration information from the second vehicle 110-2 until it receives user input to do so. In some embodiments, the first vehicle may have user-configurable settings in which the user may configure the first vehicle 110-1 to obtain calibration information automatically, or to require user authorization before doing so.

It can be noted that, even if the first vehicle 110-1 determines that calibration information is desired, it may weigh any of a variety of additional factors before choosing to initiate a communication session with the second vehicle 110-2. As noted, the use of calibration information may come at a price. As such, the cost of access to calibration information may be one such factor. In some embodiments, for example, the first vehicle 110-1 may select less-accurate, less-costly calibration information over more-accurate, more-costly calibration information.

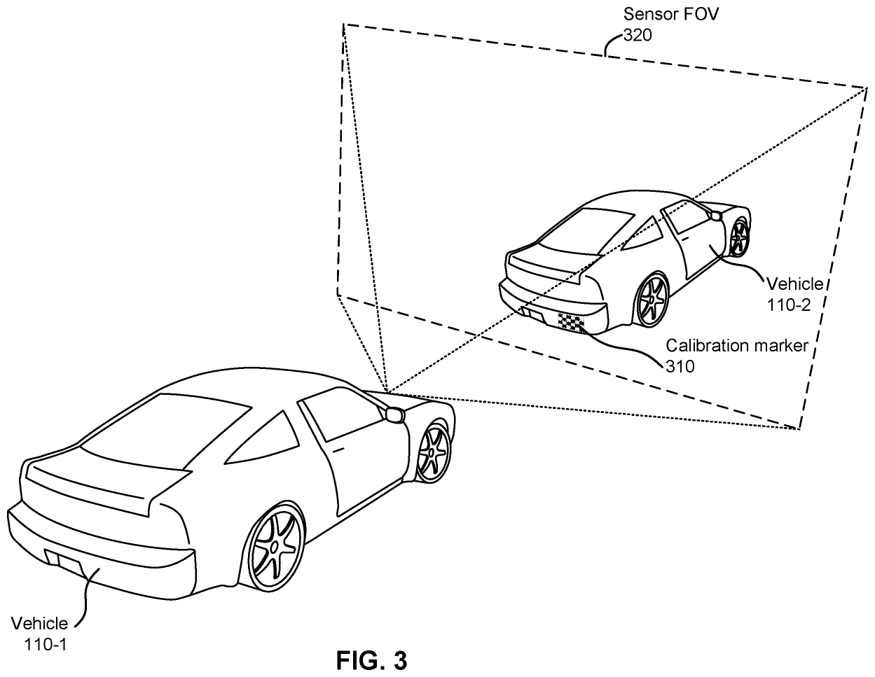

Relative location and movement may be another factor when determining whether to request calibration information from the second vehicle 110-2. If the second vehicle 110-2 is traveling in an opposite direction of the first vehicle 110-1 (or has indicated that it will do so in, for example, a V2X message), then the first vehicle 110-1 may choose not to request calibration information provided by the second vehicle 110-2 because the second vehicle 110-2 may be out of range prior to completion of the sensor calibration. Additionally, as discussed below with regard to FIG. 3, if the second vehicle 110-2 is within or near a FOV of the sensor to be calibrated, it may weigh in favor of obtaining the calibration information from the second vehicle 110-2. Furthermore as noted below, some embodiments may include a calibration marker that is not located on the second vehicle 110-2. In such embodiments, a relative location of the calibration marker to the first vehicle 110-1 may also be a factor when determining whether to request calibration information from the second vehicle 110-2.

Communication-related factors may also be weighed when determining whether to request calibration information from the second vehicle 110-2. For example, quality of communication (signal strength, direct line of sight, etc.) from messages sent by the second vehicle 110-2 may be another factor, where poor quality would weigh against obtaining calibration information from the second vehicle 110-2. A communication method or version (e.g., a version of V2X) also may be a consideration, because it may impact the speed at which calibration information may be conducted.

Additionally, the determination of whether to request calibration information from the second vehicle 110-2 may also take into account whether or not the second vehicle 110-2 is a trusted source. Incorrect information received by a vehicle may compromise the safety of passengers in the vehicle if it is used by the vehicle for maneuvering through traffic. Thus, traffic-related communications such as V2X often utilize a trust-based mechanism help authenticate communications. For example, each vehicle may have and communicate trust certificates to establish trusted V2X communications. According to some embodiments, this can be used by the first vehicle 110-1 to term and whether to request calibration information from the second vehicle 110-2. (Moreover, a similar procedure to establish trusted communications can be later used by the first vehicle 110-1 and the second vehicle 110-2 in initiating the communication session at action 240, if calibration information is later communicated.)

In some embodiments, the use of some or all of these factors by the first vehicle 110-1 to determine whether to request calibration information from the second vehicle 110-2 may be further based on user settings. That is, in such embodiments, a user may be able to adjust one or more of these factors based on personal preferences. For example, a user may be able to indicate to the first vehicle 110-1 (e.g. via a display in the first vehicle 110-1 or via an app executed by a mobile device in communication with the first vehicle 110-1) a preference for the first vehicle 110-1 automatically requesting calibration information whenever such information is free, and requiring user authorization whenever calibration information is not free.

The way in which the first vehicle 110-1 initiates a communication session with the second vehicle 110-2 may vary, depending on the type of communication used. In some embodiments, the first of vehicle 110-1 and a second vehicle 110-2 may establish direct peer-to-peer (P2P) communication (e.g., C-V2X PC5 Interface, Wi-Fi Direct, direct cellular communication, etc.), after the first vehicle 110-1 sends a request to the second vehicle 110-2 in response to the message broadcast by the second vehicle 110-2 at action 210. This request may include an indication of a desire for the calibration information, including which type of calibration is desired if multiple types of calibration information are available. Additionally, as previously noted, a money exchange (or other value exchange) may be made for the calibration information. In such instances, initiating the communication session may involve such an exchange.

At action 250, the communication session is conducted between the first vehicle 110-1 and the second vehicle 110-2 in which the second vehicle provides the calibration information to the first vehicle 110-1. Depending on the type of sensor to be calibrated, the specific calibration information may vary. However, in general, the calibration information can comprise a timestamp of a particular time, and location information regarding the location of a calibration marker at the particular time. An illustration of an embodiment is provided in FIG. 3.

FIG. 3 is a perspective drawing of a scenario in which the first vehicle 110-1 is able to calibrate a sensor based on information received by the second vehicle 110-2, according to an embodiment. Here, a calibration marker 310 is located within the sensor FOV 320 of the sensor to be calibrated (e.g., a camera of the first vehicle 110-1). It will be understood that the relative position of the vehicles may be different in different scenarios, depending on the FOVs, sensing range, and/or other sensing characteristics of the sensor to be calibrated.

The calibration process can be described generally as follows. As noted, the second vehicle 110-2 can provide the first vehicle 110-1 with calibration information comprising a time and location of the calibration marker 310. Because the calibration marker is located within the sensor FOV 320, the first vehicle 110-1 can compare the timestamp and calibration marker location received in the calibration information with an estimated location at the corresponding time based on the position of the calibration marker 310 within the sensor FOV 320. In other words, the first vehicle 110-1 can compare the actual location of the calibration marker 310 as indicated in the calibration information with an estimated location of the calibration marker based on information provided by the sensor. The first vehicle 110-1 can then adjust sensor data accordingly to calibrate the sensor (e.g., by determining the orientation of the sensor relative to the first vehicle 110-1). In some embodiments, the second vehicle 110-2 may provide calibration data over a period of time, providing multiple timestamps and corresponding locations for the calibration marker 310, resulting in multiple points of data for the first vehicle 110-1 to use and sensor calibration. Moreover, in some embodiments, the calibration process may be transparent to a driver of the first vehicle 110-1. In some embodiments, some feedback may be provided to the driver to ensure first vehicle 110-1 is situated such that the calibration marker 310 is within the sensor FOV 320 during the calibration process.

As illustrated in FIG. 3, the calibration marker 310 may comprise a visible marker at a known location relative to the second vehicle 110-2, and having a known pattern and dimension. Visible markers can be used to calibrate a camera of the first vehicle 110-1 and may include any of a variety of patterns, logos, and so forth. Although the calibration marker 310 is illustrated in FIG. 3 as being a sticker located on the back bumper of the second vehicle 110-2, the calibration marker 310 may be located anywhere. In some embodiments, the calibration marker 310 comprise a projected image on the back window of the second vehicle 110-2, a pattern displayed by a digital license plate of the second vehicle 110-2, or the like. In some embodiments, a portion or all of the vehicle 110-2 itself may be used as a calibration marker 310. To calibrate a camera of the first vehicle 110-1, if the calibration marker 310 is within the sensor FOV 320 of the camera, certain pixels of the camera's sensor will detect the calibration marker 310. Calibration information provided by the second vehicle 110-2 may include the location (latitude, longitude, and elevation) and orientation (pitch, roll, and yaw) at one or more times (as indicated by one or more timestamps). In some embodiments, the location and orientation information may also include a confidence or accuracy indicator, indicating a degree of accuracy or confidence level associated with the location and orientation information. Optionally, the calibration information may further include an indication of what the calibration marker 310 looks like (size, pattern, etc., which may be shared as an image file or other descriptor). In some embodiments, for example, there may be a set of predetermined calibration markers with known characteristics (patterns, sizes, etc.), and the calibration information may comprise a descriptor of which calibration marker, of the predetermined set, is used. With this calibration information, the first vehicle 110-1 can then calibrate the camera by establishing the relationship of the location of the calibration marker 310 with the camera pixels onto which the image of the calibration marker falls, comparing the calibration information with images taken by the camera at the one or more times. To do so, the first vehicle 110-1 may further determine its own location and orientation at the one or more times, and use a known position of the camera on the first vehicle 110-1. The calibration process can occur while the first vehicle 110-1 and a second vehicle 110-2 are moving. Thus, if the calibration data of the second vehicle 110-2 includes the location and orientation of the calibration marker 310 at multiple times, this can provide multiple data points for calibration of the camera by the first vehicle 110-1.

In situations where data obtained by the sensor of the first vehicle 110-1 is not obtained at the precise time of the timestamp in the calibration information, and the calibration marker 310 is moving (e.g., located on a moving vehicle), accommodations can be made to help ensure the sensor is adequately calibrated. In some embodiments, for example, the first vehicle 110-1 will calibrate the sensor based on calibration information having a timestamp that most closely matches the time at which sensor data was obtained. Additionally or alternatively, the second vehicle 110-2 may also include movement information (e.g., a movement vector) in the calibration information two allow the first vehicle 110-2 to determine a position of the calibration marker 310 at the precise time sensor data was obtained (e.g., based on a timestamp of calibration information, and a velocity of the calibration marker 310).

It can be noted that, although the calibration marker 310 illustrated in FIG. 3 is located on the second vehicle 110-2 providing the calibration information, embodiments are not so limited. The second vehicle 110-2 may provide the first vehicle 110-1 with calibration information for a calibration marker 310 not located on the second vehicle 110-2 (but still within the sensor FOV 320 of the sensor to be calibrated). In some embodiments, for example, calibration marker 310 may be located on signs along the road, overpasses, light posts etc.

Further, although the embodiment illustrated in FIG. 3 illustrates a visible calibration marker 310 for use in calibrating a camera, other calibration marker types can be used to calibrate other types of sensors. For example, a calibration marker for LIDAR may include a specific 3D shape that is identifiable in the point cloud created by a LIDAR scan. For radar, a calibration marker may comprise an active or passive target (e.g., a corner cube reflector). As a person of ordinary skill in the art will appreciate, non-camera sensors such as radar and LIDAR may have a sensor FOV defining the boundaries of an area or volume sensed by the respective sensor, similar to the sensor FOV 320 illustrated in FIG. 3.

In some embodiments, the second vehicle 110-2 may have multiple calibration markers 310, and may provide calibration information for a second calibration marker (not shown) if additional calibration information is needed by the first vehicle 110-1. For example, if the first vehicle 110-1 is unable to calibrate a sensor using calibration information for a first calibration marker (e.g., the first calibration marker is not within the sensor FOV 320, the calibration information for the first calibration marker is insufficient to calibrate a sensor, etc.) the first vehicle 110-1 may request calibration information for a second calibration marker, a third calibration marker, etc. in that sense, the communication session 250 of FIG. 2 may comprise multiple requests from the first vehicle 110-1 with multiple corresponding responses from the second vehicle 110-2.

Returning to FIG. 2, once the communication session has ended, the first vehicle 110-1 can complete calibration, at action 260. The first vehicle 110-1 and second vehicle 110-2 can further and the communication session, at action 270. After calibration, the first vehicle 110-1 may perform a check of data from the calibrated sensor to verify values of the data is within acceptable or expected ranges. That is, by performing checks on the data similar to checks used to determine calibration of the sensor was necessary, the first vehicle 110-1 can verify the data is not clearly errant. In some embodiments, this verification process may performed prior to ending the communication session with the second vehicle 110-2.

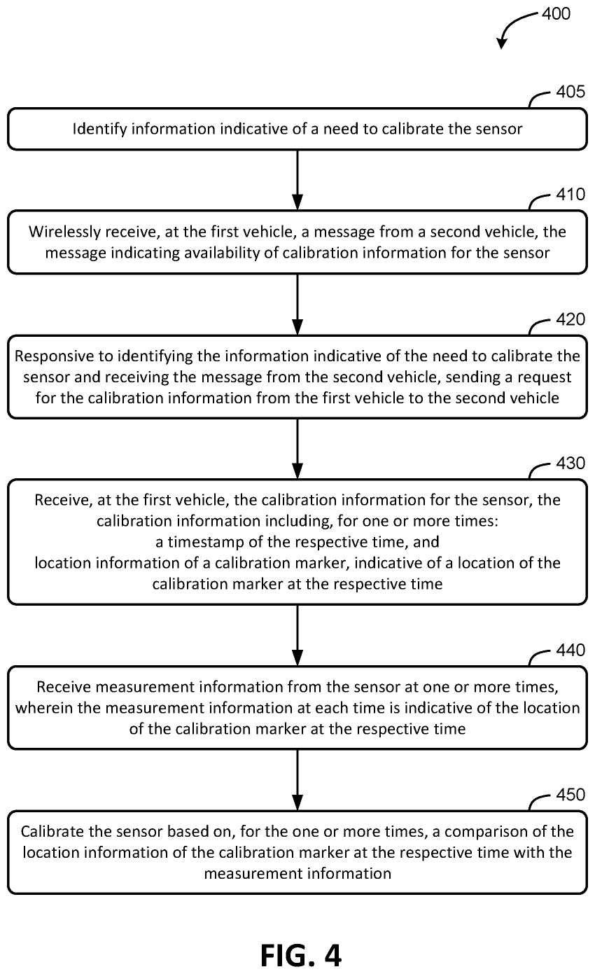

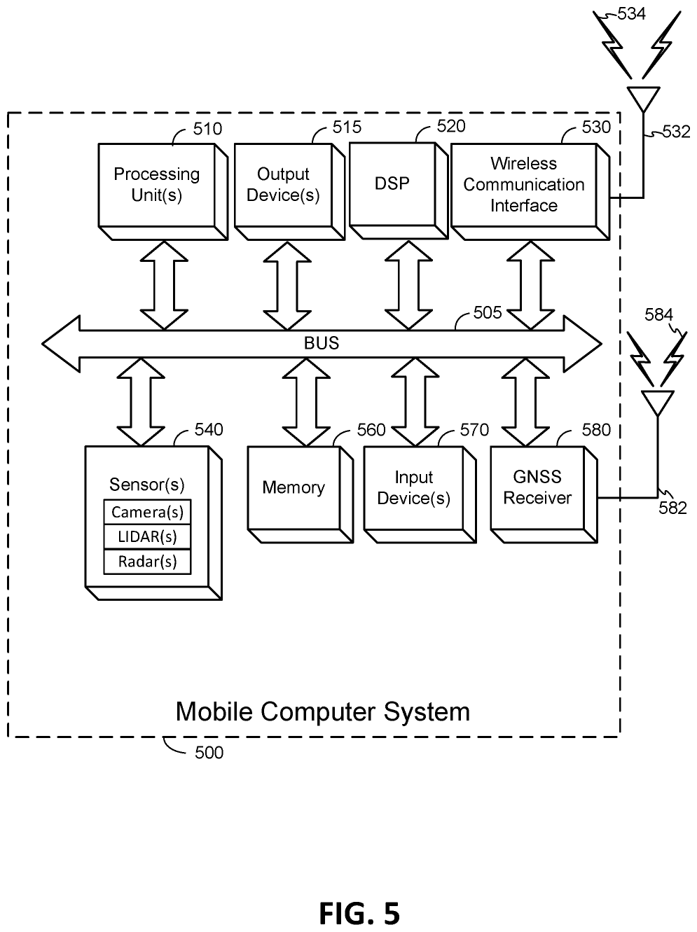

FIG. 4 is a flow diagram of a method 400 of sensor calibration for a sensor of the first vehicle, according to an embodiment. Alternative embodiments may vary in function by combining, separating, or otherwise varying the functionality described in the blocks illustrated in FIG. 4. Means for performing the functionality of one or more of the blocks illustrated in FIG. 4 may comprise hardware and/or software components of a computer system, such as the mobile computer system 500 illustrated in FIG. 5 and described in more detail below.

The functionality at block 405 comprises identifying information indicative of a need to calibrate the sensor. This can corresponds to the determination that calibration information is desired (block 220 of FIG. 2) and, depending on desired functionality, may occur before or after the first vehicle receives information from the second vehicle of the availability of such calibration information. As noted, identifying information indicative of the need to calibrate the sensor may comprise determining data from the sensor has at least one value outside and established (e.g., “normal”) range, determining data from the sensor conflicts with sensor data from one or more additional sensors (e.g., where data from the one or more sensors are determined to be reliable), determining the first vehicle has experienced an acceleration event that exceeds an acceleration threshold, or determining a threshold amount of time has elapsed since the sensor was last calibrated, or any combination thereof. Means for performing the functionality at block 405 may include one or more software and/or hardware components of a mobile computer system, such as a bus 505, processing unit(s) 510, memory 560, wireless communication interface 530, and/or other software and/or hardware components of a mobile computer system 500 as illustrated in FIG. 5 and described in more detail below.

At block 410, the functionality comprises wirelessly receiving, at the first vehicle, a message from the second device, the message indicating availability of calibration information for the sensor. As previously noted, some embodiments may leverage existing messages, such as a V2X BSM message, to convey the availability of the calibration information. Additionally or alternatively, however, the availability of the calibration information may be provided in a separate message. Means for performing the functionality at block 410 may include one or more software and/or hardware components of a mobile computer system, such as a bus 505, processing unit(s) 510, memory 560, wireless communication interface 530, and/or other software and/or hardware components of a mobile computer system 500 as illustrated in FIG. 5 and described in more detail below.

At block 420, the functionality comprises, responsive to identifying the information indicative of the need to calibrate the sensor and receiving the message from the second vehicle, sending a request for the calibration information from the first vehicle to the second vehicle. As noted in the above-described embodiments, the first vehicle may first determine that a sensor may require calibration based on a triggering event, such as the passage of a threshold amount of time, detection (from sensor data) of an impact or acceleration above a certain threshold. Furthermore, even in instances in which the first vehicle determines sensor calibration is needed, it may further determine to establish the data communication link (e.g., by sending a request to initiate a communication session to the second vehicle) based on one or more factors. As noted, these factors may include a direction of travel of the second vehicle, a quality of communication received at the first vehicle from the second vehicle, a trust certificate received from the second vehicle, a type of the calibration information, or a cost of the calibration information, or any combination thereof.

Means for performing the functionality at block 420 may include one or more software and/or hardware components of a mobile computer system, such as a bus 505, processing unit(s) 510, memory 560, wireless communication interface 530, and/or other software and/or hardware components of a mobile computer system 500 as illustrated in FIG. 5 and described in more detail below.

The functionality at block 430 comprises receiving, at the first vehicle via the data communication link, the calibration information for the sensor. The calibration information includes, for one or more times, a timestamp of the respective time, and location information of a calibration marker, indicative of a location of the calibration marker at the respective time. As noted, in some embodiments, the calibration information may include additional information, such as orientation information of the calibration marker, identification information for the calibration marker (e.g., an image file or other descriptor), or the like. Means for performing the functionality at block 430 may include one or more software and/or hardware components of a mobile computer system, such as a bus 505, processing unit(s) 510, memory 560, wireless communication interface 530, and/or other software and/or hardware components of a mobile computer system 500 as illustrated in FIG. 5 and described in more detail below.

At block 440, the functionality comprises receiving measurement information from the sensor at one or more times, wherein the measurement information at each time is indicative of the location of the calibration marker at the respective time. The measurement information may vary, depending on the type of sensor. Where the sensor comprises a camera, for instance, measurements may be based on one or more images (e.g., frames of video) of the calibration marker. Where the sensor comprises a LIDAR or radar, measurements may be based on the resulting LIDAR or radar scan. Means for performing the functionality at block 440 may include one or more software and/or hardware components of a mobile computer system, such as a bus 505, processing unit(s) 510, memory 560, sensor(s) 540, GNSS receiver 580, wireless communication interface 530, and/or other software and/or hardware components of a mobile computer system 500 as illustrated in FIG. 5 and described in more detail below.

The functionality at block 450 comprises calibrating the sensor based on, for the one or more times, a comparison of the location information of the calibration marker at the respective time with the measurement information from the sensor. As indicated in the embodiments previously discussed, a location of the calibration sensor can be estimated based on the measurement information. For a camera, for instance, the location of the calibration marker can be estimated based on a mapping of the pixels of the camera sensor (onto which an image of the calibration falls) to a physical location relative to the camera. Based on the location of the first vehicle and the camera's position on the vehicle, this estimated location may be converted to absolute coordinates (and/or another coordinate system) in which the estimated location can be compared with the location of the calibration marker provided in the calibration information. Any difference between the estimated location based on sensor measurements with the location provided in the calibration information can then be used, as explained above, to calibrate the sensor. This can be done for each time of the one or more times so that calibration information for multiple times provides multiple data points that can be used for increased accuracy in the sensor calibration. In some embodiments, orientation of the calibration marker (in addition to location) may be provided in the calibration data and estimated from sensor measurements. These can also be compared, and the results can also be used for sensor calibration.

Means for performing the functionality at block 450 may include one or more software and/or hardware components of a mobile computer system, such as a bus 505, processing unit(s) 510, memory 560, sensor(s) 540, GNSS receiver 580, wireless communication interface 530, and/or other software and/or hardware components of a mobile computer system 500 as illustrated in FIG. 5 and described in more detail below.

As indicated in the previously-described embodiments, the method 400 may include any of a variety of additional features, depending on desired functionality. For example, in some embodiments, one or more additional sensors may be used to verify calibration information and/or data from the calibrated sensor. For example, in some instances, the one or more additional sensors (e.g., additional cameras/LIDARs/radars having an overlapping sensor FOV with the sensor to be calibrated) may be used to determine an estimate for the location of the calibration marker. This estimate may be used to verify that the location of the calibration marker provided in the calibration information is correct (e.g., within a threshold distance of the estimate). Additionally or alternatively, an estimate of the location of an object based on the one or more sensors can be compared with a location of the object based on measurements from the calibrated sensor to verify that calibration was successful.

FIG. 5 illustrates an embodiment of a mobile computer system 500, which may be utilized as described hereinabove. For example, the mobile computer system 500 may comprise a vehicle computer system used to manage one or more systems related to the vehicle's navigation and/or automated driving, as well as communicate with other on-board systems and/or other traffic entities. The mobile computer system 500 may be used to operate and/or calibrate vehicle sensors, and may, therefore, perform one or more of the functions of method 400 of FIG. 4. It should be noted that FIG. 5 is meant only to provide a generalized illustration of various components, any or all of which may be utilized as appropriate. It can be noted that, in some instances, components illustrated by FIG. 5 can be localized to a single physical device and/or distributed among various networked devices, which may be disposed at different physical locations on a vehicle.

The mobile computer system 500 is shown comprising hardware elements that can be electrically coupled via a bus 505 (or may otherwise be in communication, as appropriate). The hardware elements may include a processing unit(s) 510 which can include without limitation one or more general-purpose processors, one or more special-purpose processors (such as digital signal processing (DSP) chips, graphics acceleration processors, application-specific integrated circuits (ASICs), and/or the like), and/or other processing structure or means. As shown in FIG. 5, some embodiments may have a separate Digital Signal Processor (DSP) 520, depending on desired functionality. Sensor calibration and/or processing of calibration information and/or sensor measurement information may be provided in the processing unit(s) 510. The mobile computer system 500 also can include one or more input devices 570, which can include devices related to user interface (e.g., a touch screen, touch pad, microphone, button(s), dial(s), switch(es), and/or the like) and/or devices related to navigation, automated driving, and the like. Similarly, the one or more output devices 515 may be related to interacting with a user (e.g., via a display, light-emitting diode(s) (LED(s)), speaker(s), etc.), and/or devices related to navigation, automated driving, and the like.

The mobile computer system 500 may also include a wireless communication interface 530, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device and/or various cellular devices, etc.), and/or the like, which may enable the mobile computer system 500 to communicate to other traffic entities (e.g., RSUs, other vehicles, etc.) via V2X and/or other communication standards. The communication can be carried out via one or more wireless communication antenna(s) 532 that send and/or receive wireless signals 534.

The mobile computer system 500 can further include sensor(s) 540. In the embodiments described above, this can include the sensor to be calibrated and/or one or more additional sensors for cross-calibration, such as camera(s), LIDAR(s) and radar(s), as shown.. Sensor(s) 540 additionally may comprise, without limitation, one or more accelerometers, gyroscopes, magnetometers, altimeters, microphones, proximity sensors, light sensors, barometers, and the like. Sensor(s) 540 may be used, for example, to determine certain real-time characteristics of the vehicle and nearby objects, such as location, velocity, acceleration, and the like.

Embodiments of the mobile computer system 500 may also include a GNSS receiver 580 capable of receiving signals 584 from one or more GNSS satellites using an antenna 582 (which could be the same as antenna 532). Positioning based on GNSS signal measurement can be utilized to determine a current location of the vehicle, which, as discussed above, may be used in sensor calibration as described herein. The GNSS receiver 580 can extract a position of the mobile computer system 500, using conventional techniques, from GNSS satellites of a GNSS system, such as Global Positioning System (GPS) and/or similar systems.

The mobile computer system 500 may further include and/or be in communication with a memory 560. The memory 560 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 560 of the mobile computer system 500 also can comprise software elements (not shown in FIG. 5), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 560 that are executable by the mobile computer system 500 (and/or processing unit(s) 510 or DSP 520 within mobile computer system 500). In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special-purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special-purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

What is claimed is:

1. A method of sensor calibration for a sensor of a first vehicle, the method comprising:
identifying information indicative of a need to calibrate the sensor;
wirelessly receiving, at the first vehicle, a message from a second vehicle, the message indicating availability of calibration information for the sensor;
responsive to identifying the information indicative of the need to calibrate the sensor and receiving the message from the second vehicle, sending a request for the calibration information from the first vehicle to the second vehicle;
receiving, at the first vehicle, the calibration information for the sensor, the calibration information including, for one or more times:
a timestamp of the respective time, and
location information of a calibration marker, indicative of a location of the calibration marker at the respective time;
receiving measurement information from the sensor at one or more times, wherein the measurement information at each time is indicative of the location of the calibration marker at the respective time; and
calibrating the sensor based on, for the one or more times, a comparison of the location information of the calibration marker at the respective time with the measurement information.

2. The method of claim 1, wherein sending the request for the calibration information from the first vehicle to the second vehicle based at least in part on:
a location of the second vehicle;
a direction of travel of the second vehicle;
a quality of communication received at the first vehicle from the second vehicle;
a trust certificate received from the second vehicle;
a type of the calibration information; or
a cost of the calibration information; or
any combination thereof.

3. The method of claim 1, wherein the message comprises a vehicle-to-everything (V2X) Basic Safety Message (BSM).

4. The method of claim 1, wherein the sensor comprises a camera, and the location information for the respective time is further indicative of an orientation of the calibration marker at the respective time.

5. The method of claim 1, wherein the sensor comprises a LIDAR or a radar.

6. The method of claim 1, further comprising using one or more additional sensors of the first vehicle to:
verify the received calibration information, or
verify the calibration of the sensor, or
both.

7. The method of claim 1, further comprising receiving, at the first vehicle, identification information for the calibration marker, and wherein calibrating the sensor is further based on the identification information.

8. The method of claim 1, wherein the location of the calibration marker is on the second vehicle.

9. The method of claim 1, wherein identifying information indicative of a need to calibrate the sensor comprises:
determining data from the sensor has at least one value outside an established range,
determining data from the sensor conflicts with sensor data from one or more additional sensors,
determining the first vehicle has experienced an acceleration event that exceeds an acceleration threshold, or
determining a threshold amount of time has lapsed since the sensor was last calibrated,
or any combination thereof.

10. A mobile computer system comprising:
a wireless communication interface;
a memory;
one or more processing units communicatively coupled with the memory and the wireless communication interface, the one or more processing units configured to:
identify information indicative of a need to calibrate a sensor of a first vehicle;
wirelessly receive, via the wireless communication interface, a message from a second vehicle, the message indicating availability of calibration information for the sensor;
responsive to identifying the information indicative of the need to calibrate the sensor and receiving the message from the second vehicle, send a request for the calibration to the second vehicle via the wireless communication interface;
receive, via the wireless communication interface, the calibration information for the sensor, the calibration information including, for one or more times:
a timestamp of the respective time, and
location information of a calibration marker, indicative of a location of the calibration marker at the respective time;
receive measurement information from the sensor at one or more times, wherein the measurement information at each time is indicative of the location of the calibration marker at the respective time; and
calibrate the sensor based on, for the one or more times, a comparison of the location information of the calibration marker at the respective time with the measurement information.

11. The mobile computer system of claim 10, wherein the one or more processing units are further configured to send the request for the calibration information to the second vehicle based at least in part on:
a location of the second vehicle;
a direction of travel of the second vehicle;
a quality of communication received at the first vehicle from the second vehicle;
a trust certificate received from the second vehicle;
a type of the calibration information; or
a cost of the calibration information; or
any combination thereof.

12. The mobile computer system of claim 10, wherein the one or more processing units are further configured to receive the message as a vehicle-to-everything (V2X) Basic Safety Message (BSM).

13. The mobile computer system of claim 10, wherein the sensor comprises a camera, and wherein the one or more processing units are further configured to determine, from the location information for the respective time, an orientation of the calibration marker at the respective time.

14. The mobile computer system of claim 10, wherein, to calibrate the sensor, the one or more processing units are further configured to calibrate a LIDAR or a radar.

15. The mobile computer system of claim 10, wherein the one or more processing units are further configured to use one or more additional sensors of the first vehicle to:
verify the received calibration information, or
verify the calibration of the sensor, or
both.

16. The mobile computer system of claim 10, wherein the one or more processing units are further configured to receive, via the wireless communication interface, identification information for the calibration marker, and wherein the one or more processing units are configured to calibrate the sensor further based on the identification information.

17. The mobile computer system of claim 10, wherein, to identify information indicative of a need to calibrate the sensor, the one or more processing units are configured to:
determine data from the sensor has at least one value outside an established range,
determine data from the sensor conflicts with sensor data from one or more additional sensors,
determine the first vehicle has experienced an acceleration event that exceeds an acceleration threshold, or
determine a threshold amount of time has lapsed since the sensor was last calibrated,
or any combination thereof.

18. A device comprising:
means for identifying information indicative of a need to calibrate a sensor of a first vehicle;
means for wirelessly receiving a message from a second vehicle, the message indicating availability of calibration information for the sensor;
means for sending, responsive to identifying the information indicative of the need to calibrate the sensor and receiving the message from the second vehicle, a request for the calibration information from the first vehicle to the second vehicle;
means for receiving the calibration information for the sensor, the calibration information including, for one or more times:
a timestamp of the respective time, and
location information of a calibration marker, indicative of a location of the calibration marker at the respective time;
means for receiving measurement information from the sensor at one or more times, wherein the measurement information at each time is indicative of the location of the calibration marker at the respective time; and
means for calibrating the sensor based on, for the one or more times, a comparison of the location information of the calibration marker at the respective time with the measurement information.

19. The device of claim 18, wherein the means for sending the request for the calibration information from the first vehicle to the second vehicle comprise means for sending the request for the calibration information from the first vehicle to the second vehicle based at least in part on:
a location of the second vehicle;
a direction of travel of the second vehicle;
a quality of communication received at the first vehicle from the second vehicle;
a trust certificate received from the second vehicle;
a type of the calibration information; or
a cost of the calibration information; or
any combination thereof.

20. The device of claim 18, wherein the means for receiving the message comprise means for receiving the message as a vehicle-to-everything (V2X) Basic Safety Message (BSM).

21. The device of claim 18, further comprising means for determining, from the location information for the respective time, an orientation of the calibration marker at the respective time.

22. The device of claim 18, wherein the means for calibrating the sensor comprise means for calibrating a LIDAR or a radar.

23. The device of claim 18, further comprising means for using one or more additional sensors of the first vehicle to:
verify the received calibration information, or
verify the calibration of the sensor, or both.

24. The device of claim 18, further comprising means for receiving identification information for the calibration marker, and wherein means for calibrating the sensor comprise means for calibrating the sensor further based on the identification information.

25. The device of claim 18, wherein the means for identifying information indicative of a need to calibrate the sensor comprise means for:
determining data from the sensor has at least one value outside an established range,
determining data from the sensor conflicts with sensor data from one or more additional sensors,
determining the first vehicle has experienced an acceleration event that exceeds an acceleration threshold, or
determining a threshold amount of time has lapsed since the sensor was last calibrated,
or any combination thereof.

26. A non-transitory computer-readable medium having instructions stored thereby for calibrating a sensor of a first vehicle, wherein the instructions, when executed by one or more processing units, cause the one or more processing units to:
identify information indicative of a need to calibrate a sensor of a first vehicle;
wirelessly receive a message from a second vehicle, the message indicating availability of calibration information for the sensor;
responsive to identifying the information indicative of the need to calibrate the sensor and receiving the message from the second vehicle, send a request for the calibration information from the first vehicle to the second vehicle;
receive the calibration information for the sensor, the calibration information including, for one or more times:
a timestamp of the respective time, and
location information of a calibration marker, indicative of a location of the calibration marker at the respective time;
receive measurement information from the sensor at one or more times, wherein the measurement information at each time is indicative of the location of the calibration marker at the respective time; and
calibrate the sensor based on, for the one or more times, a comparison of the location information of the calibration marker at the respective time with the measurement information.

27. The non-transitory computer-readable medium of claim 26, wherein the instructions, when executed by the one or more processing units, further cause the one or more processing units to determine, from the location information for the respective time, an orientation of the calibration marker at the respective time.

28. The non-transitory computer-readable medium of claim 26, wherein the instructions, when executed by the one or more processing units, further cause the one or more processing units to use one or more additional sensors of the first vehicle to:
verify the received calibration information, or
verify the calibration of the sensor, or
both.

29. The non-transitory computer-readable medium of claim 26, wherein the instructions, when executed by the one or more processing units, further cause the one or more processing units to receive identification information for the calibration marker, and base the calibrating the sensor further on the identification information.

30. The non-transitory computer-readable medium of claim 26, wherein, to identify information indicative of a need to calibrate the sensor, the instructions, when executed by the one or more processing units, further cause the one or more processing units to:
determine data from the sensor has at least one value outside an established range,
determine data from the sensor conflicts with sensor data from one or more additional sensors,
determine the first vehicle has experienced an acceleration event that exceeds an acceleration threshold, or
determine a threshold amount of time has lapsed since the sensor was last calibrated,
or any combination thereof.
